(19) United States
(12) Patent Application Publication
(10) Pub. No.: US 2013/0196187 A1
(43) Pub. Date: Aug. 1, 2013

(54) PRISMATIC SECONDARY BATTERY

(71) Applicants: SANYO ELECTRIC CO., LTD., Osaka (JP); TOYOTA JIDOSHA KABUSHIKI KAISHA, Toyota-shi (JP)

(72) Inventors: Yoshinori Yokoyama, Kasai-shi (JP); Yasuhiro Yamauchi, Kasai-shi (JP); Hironori Harada, Nukata-gun (JP); Toshihiro Takada, Nagoya-shi (JP); Hiroshi Inukai, Toyota-shi (JP)

(73) Assignees: TOYOTA JIDOSHA KABUSHIKI KAISHA, Toyota-shi (JP); SANYO ELECTRIC CO., LTD., Osaka (JP)

(21) Appl. No.: 13/750,549

(22) Filed: Jan. 25, 2013

(30) Foreign Application Priority Data
Jan. 27, 2012 (JP) 2012-015464

(51) Int. Cl. H01M 2/12

(52) U.S. Cl. CPC H01M 2/1229
USPC 429/53

(57) ABSTRACT

Disclosed is a prismatic secondary battery in which a second insulating member that has a through-hole is disposed between an inversion plate and a first region of a positive electrode collector, and through the through-hole the first region of the positive electrode collector is electrically connected to the inversion plate by a connecting portion. The positive electrode collector has an annular notch portion that encircles the connecting portions connecting with the inversion plate. The product of the thickness t of the thinnest part of the notch portion and the length L of the notch portion is 0.28 to 0.57 mm². There is thus provided a high-reliability prismatic secondary battery including, between the collector and the external terminals, a current interruption mechanism that is unlikely to be damaged even if high current flows in the battery.

### TECHNICAL FIELD

The present invention relates to a prismatic secondary battery, such as a nonaqueous electrolyte secondary battery or nickel-hydrogen secondary battery, that internally includes a current interruption mechanism.

### BACKGROUND ART

As the drive power sources for portable electronic equipment such as mobile telephones (including smartphones), portable computers, PDAs, and portable music players, much use is made of alkaline secondary batteries and nonaqueous electrolyte secondary batteries, typified by nickel-hydrogen batteries and lithium ion batteries, respectively. Furthermore, alkaline secondary batteries and nonaqueous electrolyte secondary batteries are also much used as drive power sources for electric vehicles (EVs) and hybrid electric vehicles (HEVs, PHEVs), and in stationary storage battery systems in applications for curbing output variation of photovoltaic power generation and wind power generation, etc., in grid power peak load shifting applications for storing power at night and using it in the daytime, and in other applications. Particularly in EV, HEV and PHEV applications or stationary storage battery systems, high capacity and high output characteristics are required. Individual batteries accordingly get larger and are used connected in series or in parallel. Prismatic secondary batteries are widely used in such cases, because of their space efficiency.

Materials extremely rich in reactivity are used for the batteries in such applications, and particularly for nonaqueous electrolyte secondary batteries. Consequently, such batteries are required to have much higher safety than the secondary batteries used for small-sized portable equipment. Therefore, prismatic secondary batteries that are used for applications of the foregoing kinds are provided not only with a gas escape valve for releasing the battery outer casing internal pressure when it increases, but also with a current interruption mechanism for breaking the electrical connection between the external terminals and the electrode assembly inside the outer casing—as set forth, for example, in JP-A-2008-66254, JP-A-2008-66255 and JP-A-2010-212034.

For example, JP-A-2008-66254 discloses the invention of a prismatic secondary battery 50 that, as shown in FIG. 7A, includes an external terminal 53 having a through-hole 52 putting a current interruption mechanism 51 in communication with the space exterior to the prismatic secondary battery 50, and is so configured that the current interruption mechanism 51 is reliably actuated when the pressure inside the outer casing 54 increases. Furthermore, JP-A-2008-66255 discloses the invention of a prismatic secondary battery 60 that, as shown in FIG. 7B, includes an external terminal 63 having a through-hole 62 putting a current interruption mechanism 61 in communication with the space exterior to the prismatic secondary battery 60, and is so configured that the current interruption mechanism 61 is actuated when the pressure inside the outer casing 64 increases, and configured that the through-hole 62 is sealed by a membrane plug 65 of resin, in order to prevent moisture or oxygen from entering the current interruption mechanism 61 through the through-hole 62 and causing deterioration of the current interruption mechanism 61.

In the prismatic secondary batteries disclosed in JP-A-2008-66254 and JP-A-2008-66255, the through-hole is provided so that the battery exterior is in communication with the space in the current interruption mechanism that corresponds to the outside of the battery, and hence that the current interruption mechanism will be readily actuated when the pressure inside the outer casing increases. However, even if the pressure inside the outer casing increases due to some cause, the pressure of the gas that is produced in the battery interior will be extremely high during the abnormality, and there will be no simultaneous similar increase in the pressure inside the sealed space in the current interruption mechanism that corresponds to the outside of the battery. This means that there will be no substantial difference in the actuation of the current interruption mechanism, whether the space in the current interruption mechanism that corresponds to the outside of the battery is sealed or open.

JP-A-2010-212034 therefore discloses a prismatic secondary battery 70 that, as shown in FIG. 8, has a sealing body 71 that seals the mouth of the outer casing (omitted from the drawing), and a connection terminal 72 that is installed to the sealing body 71, with the object of rendering it difficult for electrolyte or cleaning fluid to enter the inside of the current interruption mechanism during manufacture. In this prismatic secondary battery 70, a current interruption mechanism 74 that interrupts the current in response to an increase in the pressure inside the outer casing is provided between the connection terminal 72 and a collector 73 that electrically connects the connection terminal 72 to the electrode assembly (omitted from the drawing); the connection terminal 72 has a through-hole 75 formed in its interior, the through-hole 75 which communicates with the space in the current interruption mechanism 74 that corresponds to the outside of the battery; and the through-hole 75 is sealed by a terminal plug 76 formed of an elastic member, so that a sealed space is formed between the through-hole 75 and the current interruption mechanism 74.

This current interruption mechanism 74 includes an inversion plate 77 that performs the function of a valve body, and the thin portion 73a of the collector 73. An annular groove (notch portion) 73b is formed in the thin portion 73a of the collector 73, and the inversion plate 77 is welded to the central part of the thin portion 73a. Moreover, the edge portion 77a around the periphery of the inversion plate 77 is welded to the inner circumferences of a flange portion 78a formed at the bottom end of the tubular portion of a tab member 78. The connection terminal 72 is electrically insulated from the sealing body 71 with an upper first insulating member 79 and a lower first insulating member 80 interposed therebetween, and is electrically connected to the top end of the tubular portion of the tab member 78. A second insulating member 81 of resin is disposed between the collector 73 and the inversion plate 77 at the periphery of the current interruption mechanism 74, and this second insulating member 81 is fixed to and integrated with the lower first insulating member 80 by latching-fixing portions 81a. As a result, when the pressure inside the outer casing increases, the inversion plate 77 is deformed toward the sealing body 71, and then the thin portion 73a of the collector 73 is cut through at the notch portion 73b. The electrical connection between the collector 73 and the inversion plate 77 is thus broken. This has the effect of stopping any further charging or discharging of the battery.

The prismatic secondary battery disclosed in JP-A-2010-212034 has high safety because it includes a current interruption mechanism. Moreover, during manufacture, the nonaqueous electrolyte or cleaning fluid, etc., will be unlikely to enter the current interruption mechanism. Thus, this invention offers the excellent advantages of a prismatic nonaqueous electrolyte secondary battery that includes high-reliability connection terminals.

In the EV, HEV, PHEV and stationary storage battery systems of recent years, since high current sometimes flows, protection of the system as a whole is implemented by means of a fuse that is provided for the whole system and that blows in advance in the event of an abnormality such as a brief external short-circuit, separately from the current interruption mechanisms provided in the individual prismatic secondary batteries. The current interruption mechanism used in prismatic secondary batteries of the related art is installed in order to provide protection when the pressure inside the battery increases abnormally, and the current interruption is effected through the fracturing of a brittle notch portion formed in the collector. However, the heating-up and melting of the notch portion due to the current that flows across them has substantially never been taken into account.

A fuse itself melts when high current flows, thereby interrupting the current. But there is a time lag from when the high current flows until the fuse melts. Consequently, in EV, HEV, PHEV and stationary storage battery systems, it may sometimes happen that when high current flows in a battery, the notch portion, which is the thinnest place in the collection pathways provided in the collector of the current interruption mechanism, melt before the fuse blows.

The present inventors have arrived at the present invention as a result of various experiments to determine a structure that will prevent the notch portion of the current interruption mechanism from melting when high current flows in such a prismatic secondary battery, upon discovering that a solution can be obtained by assuring a particular sectional area for the portion of the brittle notch portion through which current flows, thus reducing the density per unit area of the current that flows through the notch portion.

### SUMMARY

An advantage of some aspects of the invention is to provide a prismatic secondary battery that includes a current interruption mechanism in which melting of the notch portion is prevented when high current flows briefly in the battery.

According to an aspect of the invention, a prismatic secondary battery includes:

a prismatic outer casing that has a mouth;

an electrode assembly that is housed inside the prismatic outer casing and has a positive electrode plate and a negative electrode plate;

a positive electrode collector that is electrically connected to the positive electrode plate;

a negative electrode collector that is electrically connected to the negative electrode plate;

a sealing body that seals the mouth of the outer casing;

at least one external terminal that is inserted into a through-hole provided in the sealing body while being electrically insulated from the sealing body with a first insulating member interposed therebetween;

a conductive member that has a tubular portion;

an inversion plate containing conductive material, that is deformed when the battery interior pressure exceeds a particular value; and

a second insulating member that is interposed between the inversion plate and at least one of the positive electrode collector and the negative electrode collector, and in which a second through-hole is formed.

In the prismatic secondary battery, at least one of the positive electrode collector and the negative electrode collector is electrically connected to the inversion plate by a connecting portion through the through-hole formed in the second insulating member.

One end of the tubular portion of the conductive member is electrically connected to the external terminal, and the other end is sealed by the inversion plate.

At least one of the positive electrode collector and the negative electrode collector has an annular notch portion that encircles the connecting portion, and

the product of the thickness t of the thinnest part of the notch portion and the length L of the annular notch portion is 0.28 to 0.57 mm².

In EV, HEV, PHEV and stationary storage battery systems, which require cycling at high current, a fuse provided for the system as a whole blows to protect the system from damage if unexpectedly high current flows due to some cause. The formation material of the collector of the prismatic secondary batteries is generally aluminum or aluminum alloy, copper or copper alloy, nickel or nickel alloy, for example. With the prismatic secondary battery of the invention, the resistance of the thinnest part of the notch portion is kept low and the notch portion will be unlikely to heat up or melt even if high current flows briefly even if a generally used material is used for the collectors. Moreover a current interruption mechanism will be obtained that is actuated instantly if the battery internal pressure exceeds a particular value. Furthermore, when a high power application system is constructed incorporating the prismatic secondary battery of the invention, the notch portion will be prevented from melting before the fuse provided for the system when unexpectedly high current flows.

If the product of the thickness t of the thinnest part of the notch portion and the length L of the annular notch portion is less than 0.28 mm², the notch portion will heat up greatly and be liable to melt when high current flows. Similarly, if such product exceeds 0.57 mm², the brittle notch portion will not readily fracture, and the pressure-sensitive current interruption mechanism will not readily achieve its function. A more preferable range for the product of the thickness t of the thinnest part of the notch portion and the length L of the annular notch portion is 0.39 to 0.51 mm². Furthermore, the thickness t of the thinnest part of the notch portion is preferably 0.025 mm or more.

In the prismatic secondary battery of the invention, it is preferable that a through-hole be formed in at least one of the positive electrode collector and the negative electrode collector, and that the boundary between the sides of the through-hole and the inversion plate be welded at a plurality of locations by irradiation with a high-energy beam.

If a through-hole is not formed in at least one of the positive electrode collector and the negative electrode collector, it will be necessary to form connecting portions between the collector and the inversion plate by piercing welding. It will be therefore difficult to perform welding by irradiation with a high-energy beam, and moreover, unevenness will be prone to occur in the quality of the welded locations, that is, the connecting portions. By contrast, in the prismatic secondary battery of the invention, a through-hole is formed in at least one of the positive electrode collector and the negative electrode collector, which means that the locations to be welded between the collector and the inversion plate are exposed. Thus, it will be easy to weld the collector to the inversion plate, and moreover, the quality of the welded locations, that is, the connecting portions, will be even. A laser beam or electron beam may be used as the high-energy beam.

In the prismatic secondary battery of the invention, it is preferable that the diameter of the through-hole formed in at least one of the positive electrode collector and the negative electrode collector be 1.5 to 4.0 mm.

The diameter of the through-hole less than 1.5 mm is not preferable, since this will reduce the number of connecting portions formed between the collector and the inversion plate. This will weaken the bond strength between the collector and the inversion plate causing a risk that the connecting portions fracture before the brittle notch portion fractures in the event that the pressure inside the battery increases. The small number of few connecting portions formed between the collector and the inversion plate is not preferable because such connecting portions could melt if an unexpectedly high current flows. A diameter of the through-hole exceeding 4.0 mm is not preferable because the width of the collector will have to be larger correspondingly, and accordingly the thickness of the prismatic secondary battery will become larger.

In the prismatic secondary battery of the invention, it is preferable that a protrusion be provided around the circumference of the through-hole formed in at least one of the positive electrode collector and the negative electrode collector.

With a protrusion provided around the circumference of the through-hole, the circumferential portion of the through-hole will be thicker than the neighboring portions. Thus, it will be easy to carry out welding with a high-energy beam, and there will be little unevenness in the quality of the connecting portion. In addition, this can enlarge the connecting portion between the collector and the inversion plate, enabling the more reliable prevention of the connecting portion from melting in the event that unexpectedly high current flows.

In the prismatic secondary battery of the invention, the sectional shape of the notch portion may be roughly V-shaped, roughly U-shaped, or roughly trapezoidal.

With such structure, it will be possible to homogenize the thickness of the thinnest part of the notch portion, so that a prismatic secondary battery will be obtained in which the actuation pressure for the current interruption mechanism is steady. Furthermore, the sectional shape of the notch portion is, most preferably roughly V-shaped in consideration of ease of formation and of variation in the fracture pressure. Regarding this invention, the expression “roughly V-shaped, roughly U-shaped, or roughly trapezoidal” is used to include shapes that can be visually judged to be a V-shape, U-shape, or trapezoid that are not necessarily an exact V-shape, U-shape, or trapezoid. For example, the expression may include shapes that are a distorted V-shape, U-shape, or trapezoid, and may include an V-shape, U-shape, or trapezoid that have parts that should be straight but are curved. Preferably however, the shape is an exact V-shape, U-shape, or trapezoid.

In the prismatic secondary battery of the invention, the shape of the annular notch portion viewed from above may be round, elliptical, or polygonal.

Provided that the sectional area of the thinnest part of the annular notch portion fulfills the numeric condition of being in the above-mentioned range from 0.28 to 0.57 mm², similar advantageous effects will be yielded even if the shape of the notch portion is round, elliptical, or polygonal. In consideration of ease of formation, the shape of the notch portion viewed from above is most preferably round.

In the prismatic secondary battery of the invention, it is preferable that a positive electrode external terminal and a negative electrode external terminal be provided as the external terminals.

In prismatic secondary batteries, the outer casing can be used for the other polarity when either a positive electrode external terminal or a negative electrode external terminal is formed in the sealing plate. However, it is difficult to form a conductive pathway with low internal resistance between the other-polarity electrode plate and the outer casing. However, if both a positive electrode external terminal and a negative electrode external terminal are formed in the sealing plate, it will be possible to perform assembly with the positive electrode plate electrically connected to the positive electrode external terminal and the negative electrode plate electrically connected to the negative electrode external terminal. Thus, manufacture will be easier, and moreover, a prismatic secondary battery with superior electrical characteristics will be obtained since the internal resistance between the positive electrode plate and the positive electrode external terminal and between the negative electrode plate and the negative electrode external terminal will be small.

In the prismatic secondary battery of the invention, the electrode assembly may be a flattened electrode assembly that has a plurality of stacked positive electrode exposed portions at one end and a plurality of stacked negative electrode exposed portions at the other end, with the positive electrode exposed portions being disposed so as to face to one sidewall of the prismatic outer casing and the negative electrode exposed portions being disposed so as to face to the other sidewall of the prismatic outer casing, and with the positive electrode collector being connected to the positive electrode exposed portions and the negative electrode collector being connected to the negative electrode exposed portions.

When the positive electrode exposed portions are disposed at one end of the prismatic outer casing and the negative electrode exposed portions at the other end, the distance between the positive electrode collector and the negative electrode collector can be enlarged, and so the prismatic secondary battery can be rendered high-capacity and assembly of the prismatic secondary battery will be facilitated. In addition, with such prismatic secondary battery of the invention, the collector will be connected to the exposed portions of the stacked substrates, and so a battery with superior output characteristics will be obtained.

### BRIEF DESCRIPTION OF THE DRAWINGS

The invention will be described with reference to the accompanying drawings, wherein like numbers reference like elements.

FIG. 1A is a sectional view of a prismatic nonaqueous electrolyte secondary battery of an embodiment, FIG. 1B is a sectional view along line IB-IB in FIG. 1A, and FIG. 1C is a sectional view along line IC-IC in FIG. 1A.

FIG. 2 is a sectional view of a current interruption mechanism provided on the positive electrode side of the prismatic nonaqueous electrolyte secondary battery in FIGS. 1A to 1C, in the direction of the short sides of the outer casing.

FIG. 3 is a sectional view of the current interruption mechanism provided on the positive electrode side of the prismatic nonaqueous electrolyte secondary battery in FIGS. 1A to 1C, in the direction of the long sides of the outer casing.

FIG. 4A is an opened-out front view of the positive electrode collector of the prismatic nonaqueous electrolyte secondary battery in FIGS. 1A to 1C, and FIG. 4B is an opened-out side view of the same.

FIG. 5A is an enlarged view of portion VA in FIGS. 4A and 4B, and FIG. 5B is a sectional view along line VB-VB in FIG. 5A.

FIG. 6 is a schematic top view of the portion corresponding to FIG. 3, illustrating the dispositional relationship between a first region of a positive electrode collector and the tubular portion of a conductive member in the prismatic nonaqueous electrolyte secondary battery shown in FIGS. 1A to 1C.

FIG. 7A is a sectional view of a current interruption mechanism in a prismatic secondary battery of an example in the related art, and FIG. 7B is a sectional view of a current interruption mechanism in a prismatic secondary battery of another example in the related art.

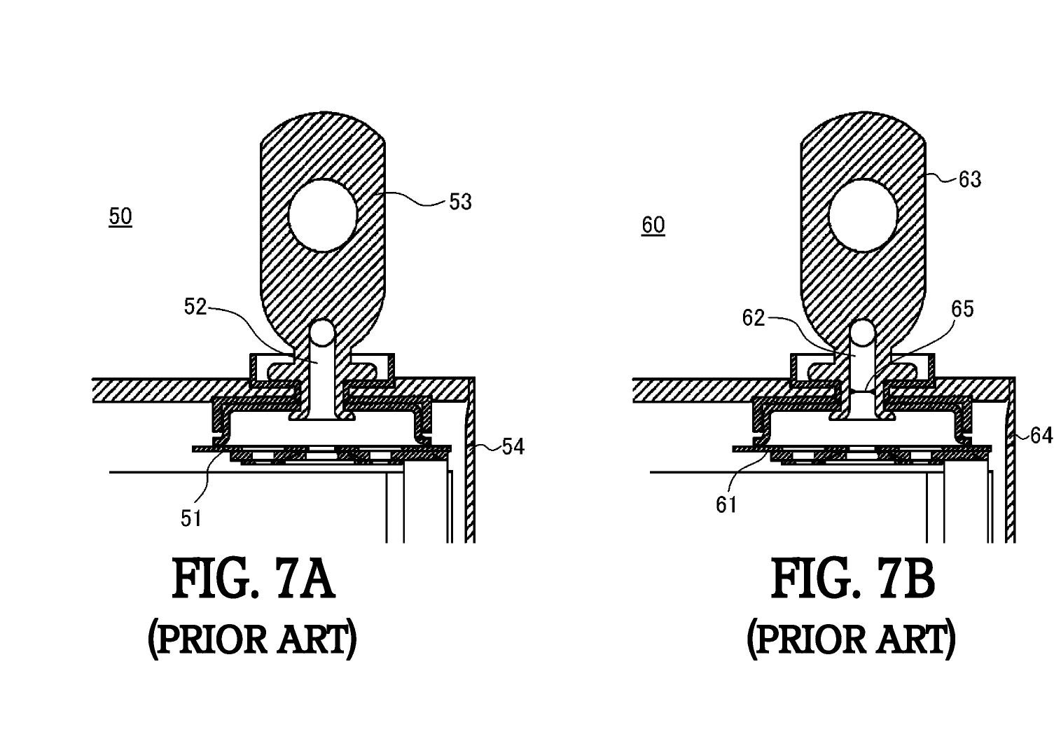

FIG. 8 is a sectional view of an external terminal in a prismatic secondary battery of still another example in the related art.

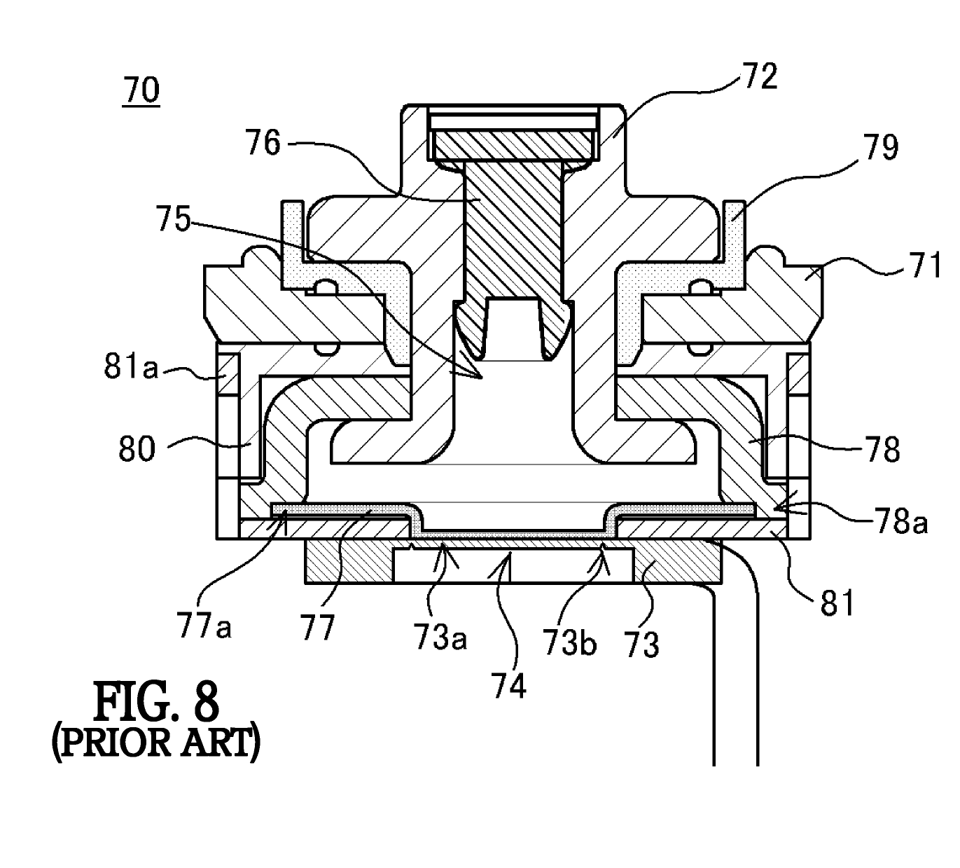

### DESCRIPTION OF EXEMPLARY EMBODIMENT

An embodiment for carrying out the invention will now be described in detail with reference to the accompanying drawings. It is to be understood, however, that the following embodiment is intended as an illustrative example of a prismatic nonaqueous electrolyte secondary battery for the purpose of comprehending the technical concepts of the invention, and is not intended to limit the invention to this particular prismatic secondary battery; the invention can equally well be applied to yield many other variants without departing from the scope and spirit of the technical concepts set forth in the claims. Note that although the invention can be applied to prismatic secondary batteries that have an electrode assembly with a flattened shape produced by stacking or by winding positive electrode plate(s) and negative electrode plate (s) together with separators interposed, the description below is of a battery with a flattened wound electrode assembly, as a representative example.

Embodiment

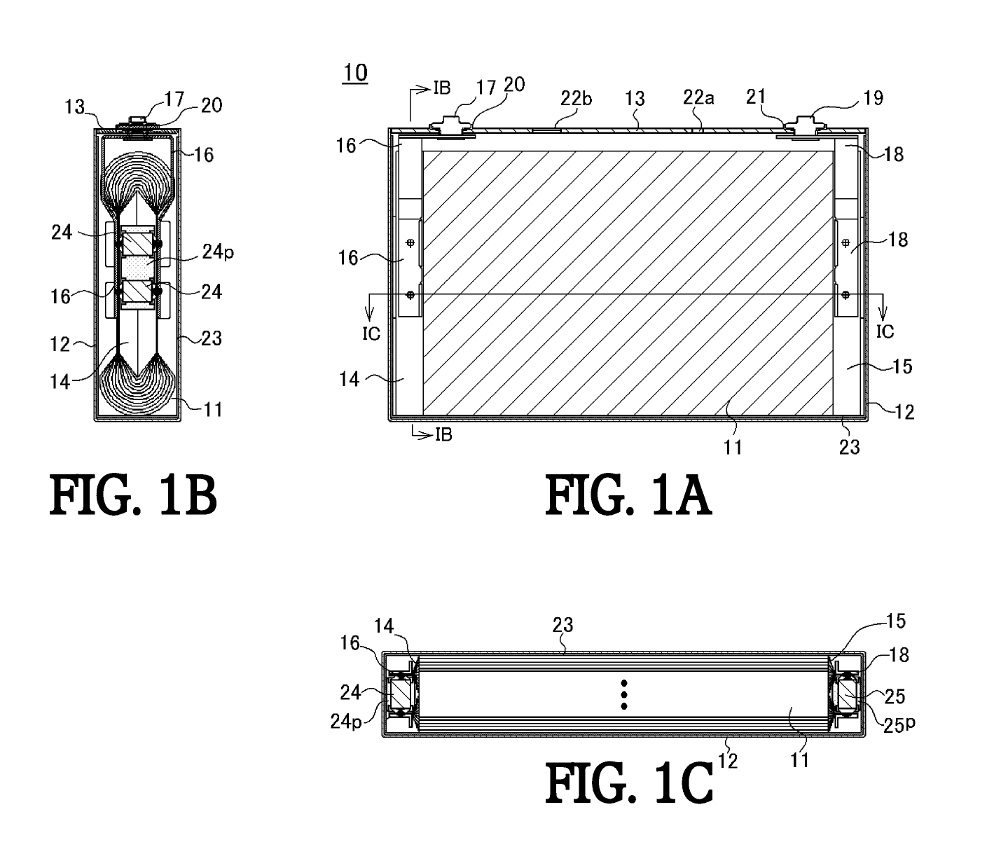

The prismatic nonaqueous electrolyte secondary battery of an embodiment will be explained below using FIGS. 1 to 6. First, the prismatic nonaqueous electrolyte secondary battery 10 of the embodiment will be described using FIGS. 1A to 1C.

The prismatic nonaqueous electrolyte secondary battery 10 of the embodiment has a flattened wound electrode assembly 11 in which a positive electrode plate and a negative electrode plate are wound together with separators (all omitted from the drawings) interposed. To fabricate the positive electrode plate, a positive electrode active material mixture is spread over both sides of a positive electrode substrate of aluminum foil, and the resulting object is dried and rolled, then is slit at one end so that the aluminum foil is exposed in strips aligned in the lengthwise direction. To fabricate the negative electrode plate, a negative electrode active material mixture is spread over both sides of a negative electrode substrate of copper foil, and the resulting object is dried and rolled, then is slit at one end so that the copper foil is exposed in strips aligned in the lengthwise direction.

The positive electrode plate and the negative electrode plate obtained in the foregoing manner are then wound together with polyethylene microporous separators interposed therebetween in a state in which neither the aluminum foil exposed portions of the positive electrode plate nor the copper foil exposed portions of the negative electrode plate overlap with the active material layer of their opposing electrode, thereby fabricating a flattened wound electrode assembly 11 that includes, at one end of the winding axis, a plurality of positive electrode substrate exposed portions 14 that are stacked, and at the other end, a plurality of negative electrode substrate exposed portions 15 that are stacked.

The positive electrode substrate exposed portions 14 are stacked together and electrically connected to a positive electrode external terminal 17 with a positive electrode collector 16 interposed therebetween. Likewise, the negative electrode substrate exposed portions 15 are stacked together and electrically connected to a negative electrode external terminal 19 with a negative electrode collector 18 interposed therebetween. The positive electrode external terminal 17 and the negative electrode external terminal 19 are fixed to a sealing body 13, with insulating members 20 and 21, respectively, interposed therebetween. In the prismatic nonaqueous electrolyte secondary battery 10 of the embodiment, a pressure-sensitive current interruption mechanism is located between the positive electrode collector 16 and the positive electrode external terminal 17 or between the negative electrode collector 18 and the negative electrode external terminal 19. The specific structure of this current interruption mechanism will be described later.

To fabricate the prismatic nonaqueous electrolyte secondary battery 10 of the embodiment, the flattened wound electrode assembly 11 fabricated in the foregoing manner is inserted into a prismatic outer casing 12, with a resin sheet 23 interposed around the periphery except at the sealing body 13. Subsequently, the sealing body 13 is laser-welded to the mouth portion of the outer casing 12, after which nonaqueous electrolyte is poured in through an electrolyte pour hole 22a and the electrolyte pour hole 22a is sealed. The sealing body 13 has a gas escape valve 22b that opens when gas pressure is exerted that exceeds the actuation pressure for the current interruption mechanism.

Furthermore, in the flattened wound electrode assembly 11 of the prismatic nonaqueous electrolyte secondary battery 10 of the embodiment, the stacked positive electrode substrate exposed portions 14 of the positive electrode plate are split into two groups, between which two intermediate conductive members 24 for the positive electrode are held. Likewise, the stacked negative electrode substrate exposed portions 15 of the negative electrode plate are split into two groups, between which two intermediate conductive members 25 for the negative electrode are held. The two positive electrode intermediate conductive members 24 and the two negative electrode intermediate conductive members 25 are held by insulative intermediate members 24p and 25p, respectively, that contains resin material.

On the outermost surface of each of the two positive electrode substrate exposed portion 14 groups, which are located at the two positive electrode intermediate conductive members 24, a positive electrode collector 16 is disposed. likewise on the outermost surface of each of the two negative electrode substrate exposed portion 15 groups, which are located at the two negative electrode intermediate conductive members 25, a negative electrode collector 18 is disposed. The positive electrode intermediate conductive members 24 contain aluminum, the same material as the positive electrode substrate. The negative electrode intermediate conductive members 25 contain copper, the same material as the negative electrode substrate. The positive electrode intermediate conductive members 24 can have a shape substantially identical to that of the negative electrode intermediate conductive members 25. The positive electrode substrate exposed portions 14 are resistance-welded both to the positive electrode collector 16 and to the positive electrode intermediate conductive members 24. Likewise, the negative electrode substrate exposed portions 15 are joined both to the negative electrode collector 18 and to the negative electrode intermediate conductive members 25 by resistance welding.

The prismatic nonaqueous electrolyte secondary battery 10 of the embodiment illustrates an example of using two positive electrode intermediate conductive members 24 and two negative electrode intermediate conductive members 25. However, it will alternatively be possible, depending on the required output of the battery, to use one each, or three or more. With a structure that uses two or more, the positive electrode intermediate conductive members 24 and the negative electrode intermediate conductive members 25 will be held by one insulative intermediate member of resin material, and so can be positioned and disposed in a stable state between the two split-up groups of substrate exposed portions.

Next will be described the methods for resistance-welding the positive electrode intermediate conductive members 24 to the positive electrode substrate exposed portions 14 of the flattened wound electrode assembly 11 and the positive electrode collector 16, and the methods for resistance-welding the negative electrode intermediate conductive members 25 to the negative electrode substrate exposed portions 15 and the negative electrode collector 18. However, the description below deals with the items on the positive electrode plate side only as being representative since in the prismatic nonaqueous electrolyte secondary battery 10 of the embodiment, the shapes of the positive electrode intermediate conductive members 24 and of the negative electrode intermediate conductive members 25 are substantially identical, and moreover the resistance-welding methods for both are substantially similar.

First, the positive electrode substrate exposed portions 14 of aluminum foil, of the flattened wound electrode assembly 11, are stacked. The stacked positive electrode substrate exposed portions 14 are split into two groups from the winding center portion outward to the two sides, and each group is bunched around a center that is the line along ¼ of the thickness of the wound electrode assembly 11. Subsequently, the positive electrode collector 16 is disposed on the outermost peripheries, and the positive electrode intermediate conductive members 24 are disposed on the inner peripheries, of the two bunches of positive electrode substrate exposed portions 14, in such a manner that the truncated cone-shaped protrusions of both of the positive electrode intermediate conductive members 24 contact against the positive electrode substrate exposed portions 14. Each bunch of aluminum foil has thickness of about 660 μm and 44 stacked substrates (for a total of 88). The items used for the positive electrode collector 16 are fabricated by punching and bend-processing, etc., a 0.8 mm-thick aluminum sheet.

Next, the flattened wound electrode assembly 11, in which the positive electrode collector 16 and the positive electrode intermediate conductive members 24 are disposed, is disposed between a pair of resistance welding electrodes, omitted from the drawings, that are disposed one above the other. Subsequently, the pair of resistance welding electrodes are brought into contact with the positive electrode collector 16, each of which is disposed on the outermost periphery of one of the two bunches of positive electrode substrate exposed portions 14. A suitable degree of pushing pressure is then applied between the pair of resistance welding electrodes, and resistance welding is performed under certain predetermined conditions. Since the protrusions of the positive electrode intermediate conductive members 24 thereby act as projections, the positive electrode collector 16 and two bunches of positive electrode substrate exposed portions 14, which have been disposed between the pair of resistance welding electrodes, heat up well and so large nuggets are formed. Consequently, the welds are of extremely high strength between the positive electrode collector 16 and the two bunches of positive electrode substrate exposed portions 14, the welds among the positive electrode substrate exposed portions 14, and the welds between the two bunches of positive electrode substrate exposed portions 14 and the positive electrode intermediate conductive members 24.

Moreover, during such resistance welding, the positive electrode intermediate conductive members 24 are disposed in a stably positioned state between the two bunches of positive electrode substrate exposed portions 14. This leads to the resistance welding in an accurate and stable state, the curbing of variation in the weld strength, and the realizing of low resistance of the welds. A prismatic secondary battery that is capable of high current cycling thus can be manufactured. By repeating such resistance welding as many times as the number of positive electrode intermediate conductive members 24 used, all of the resistance welding is executed—between the positive electrode collector 16 and the two bunches of positive electrode substrate exposed portions 14, among the positive electrode substrate exposed portions 14, and between the two bunches of positive electrode substrate exposed portions 14 and the positive electrode intermediate conductive members 24. This resistance welding is carried out in the same manner for the negative electrode.

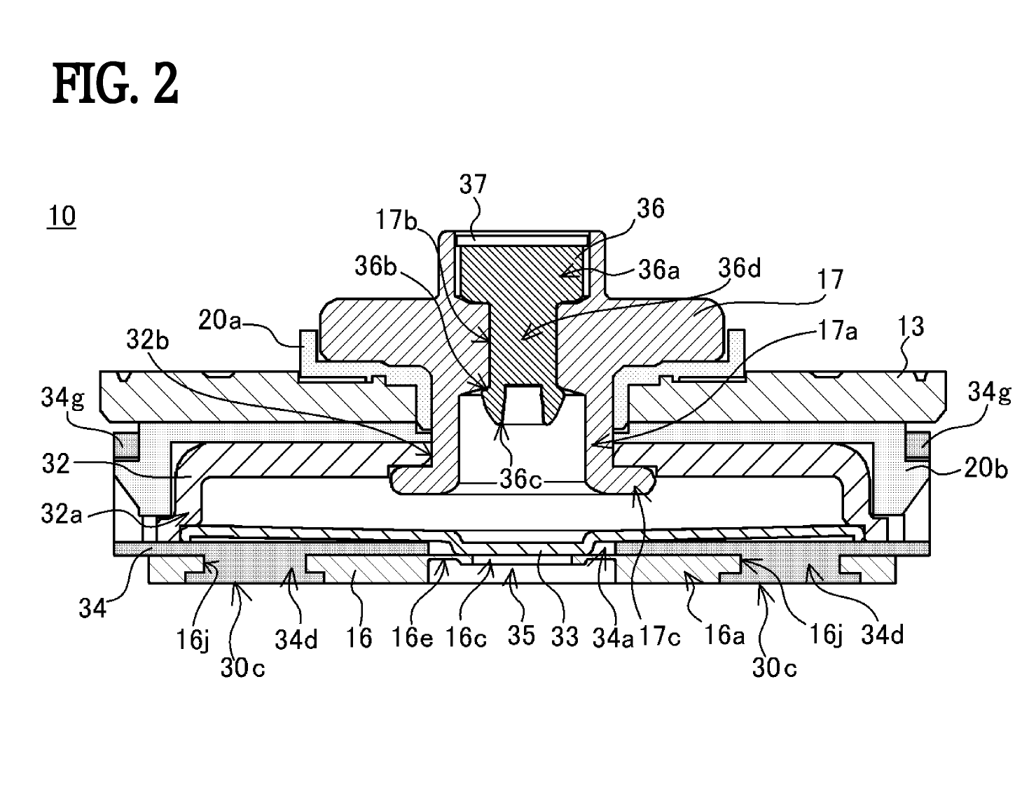

Now will be described the pressure-sensitive current interruption mechanism that is interposed between the positive electrode collector 16 and the positive electrode external terminal 17 or between the negative electrode collector 18 and the negative electrode external terminal 19. This current interruption mechanism can be provided on the positive electrode side only, on the negative electrode side only, or on both the positive electrode and negative electrode sides. Below, the case where the mechanism is provided on the positive electrode side only is described, with reference to FIGS. 2 to 6.

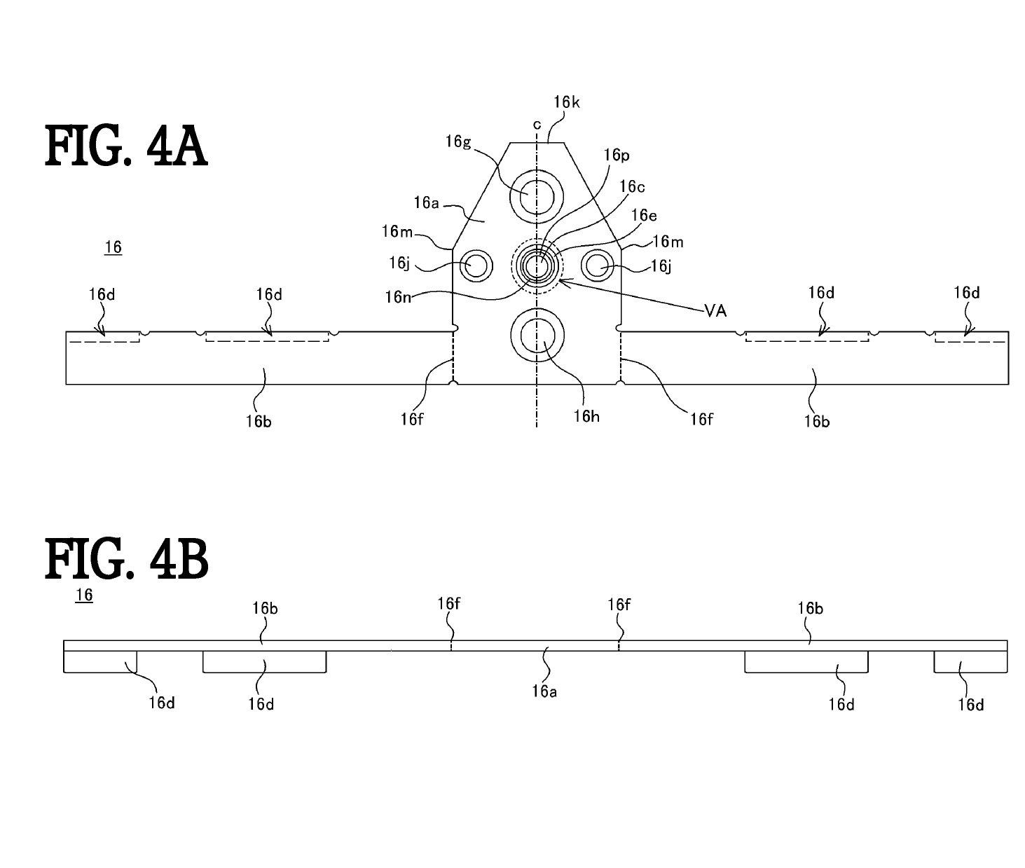

As FIGS. 1A to 1C show, the positive electrode collector 16 is connected to the positive electrode substrate exposed portions 14 disposed at one end of the wound electrode assembly 11. The positive electrode collector 16 is electrically connected to the positive electrode external terminal 17. As shown in FIGS. 4A and 4B, which are an opened-out front view and side view, respectively, positive electrode collector 16 has a first region 16a that is disposed parallel to the sealing body 13, and a pair of second regions 16b that extend outward from the first region 16a in mutually opposite directions, are folded at the dashed lines (boundaries 16f), and are connected to the positive electrode substrate exposed portions 14. The positive electrode collector 16 is fabricated by punching from aluminum sheet of thickness 0.8 mm, therefore are rigid, and cannot be folded with a small force. In FIG. 4A, notched portions are formed in both of the boundaries 16f in order to facilitate folding of the positive electrode collector 16 along the boundaries 16f.

In the central portion of the first region 16a of the positive electrode collector 16, there is formed a connection forming hole 16c. On the centerline c that passes through the center of the connection forming hole 16c in the direction of the long sides of the sealing body 13, there are formed a first opening 16g and a second opening 16h, one on each side of the connection forming hole 16c. In the direction perpendicular to the centerline c, there are formed two third openings 16j, one on each side. The diameters of the first opening 16g and second opening 16h are identical. The diameters of both two third openings 16j are identical and are determined so as to be smaller than the diameters of the first opening 16g and second opening 16h. In the second regions 16b of the positive electrode collector 16, there are formed ribs 16d on the side facing base portion of the positive electrode substrate exposed portions 14. These ribs 16d perform the roles of positioning the positive electrode collector 16 relative to the positive electrode substrate exposed portions 14, positioning the wound electrode assembly 11 relative to the battery outer casing 12, preventing the spatter that occurs during resistance welding of the positive electrode collector 16 to the positive electrode substrate exposed portions 14 from entering the wound electrode assembly 11, and so forth. The portion around the circumference of the connection forming hole 16c in the first region 16a is an annular thin region 16e whose thickness is smaller than those of the other portions.

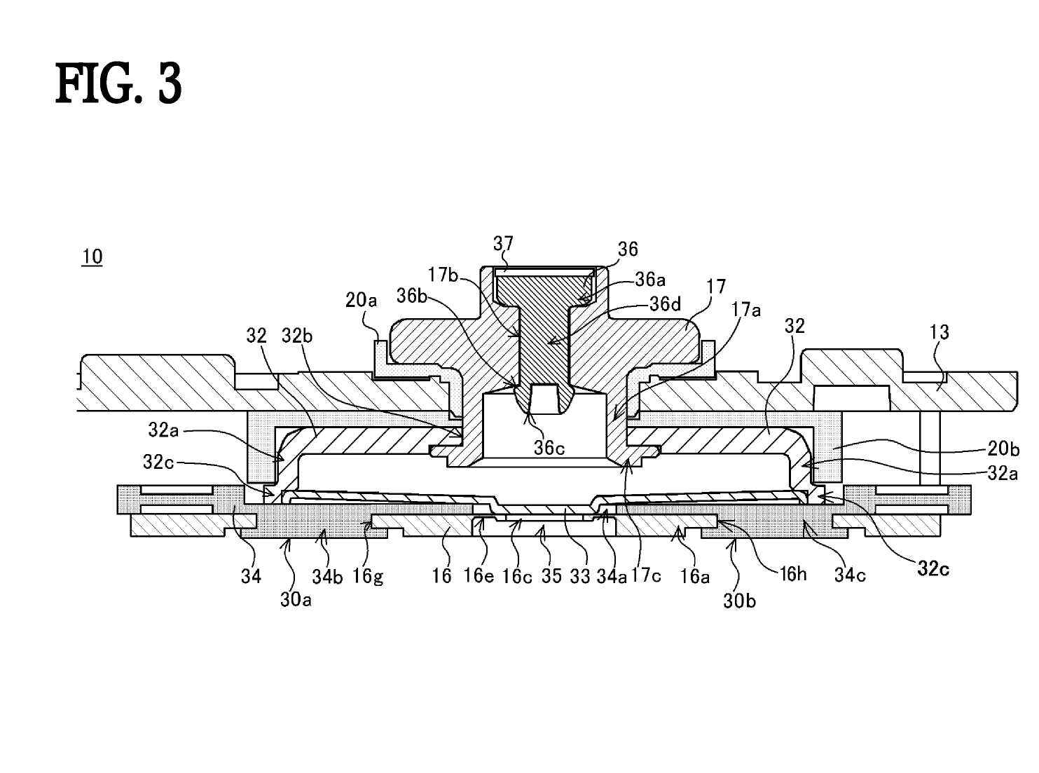

The positive electrode external terminal 17, as shown in FIGS. 2 and 3, has tubular portion 17a, and a through-hole 17b formed in its interior. The tubular portion 17a of the positive electrode external terminal 17 is inserted into holes formed in an upper first insulating member 20a such as a gasket, in the sealing body 13, in a lower first insulating member 20b and in conductive member 32 having a tubular portion 32a, and the tip portions 17c are swaged and fixed so as to be mutually integrated. The conductive member 32 has a tubular portion 32a formed at its battery interior end, while at its battery exterior end—that is, sealing body 13 end, where the diameter narrows—there is formed opening 32b into which the tubular portion 17a of the positive electrode external terminal 17 is inserted. The tip portion 17c of the tubular portion 17a of the positive electrode external terminal 17 is swaged near the opening 32b in the conductive member 32, and is laser-welded to the connection portion of the conductive member 32. Thereby, the positive electrode external terminal 17 is electrically connected to the conductive member 32 in such a state as to be electrically insulated from the sealing body 13 by the upper first insulating member 20a and the lower first insulating member 20b. Both the upper first insulating member 20a and the lower first insulating member 20b correspond to the first insulating member of the invention.

A flange portion 32c is formed at the battery interior-end tips of the tubular portion 32a of the conductive member 32, and the inner surface of this flange portion 32c is hermetically welded with the periphery of an inversion plate 33 to be sealed. The inversion plate 33 is shaped so as to protrude slightly on the battery interior side from the periphery toward the center, that is, shaped so as to be in a slanted positional relationship with the sealing body 13. The inversion plate 33 is formed of a conductive material and has the function of a valve that is deformed toward the exterior of the battery when the pressure inside the outer casing 12 increases.

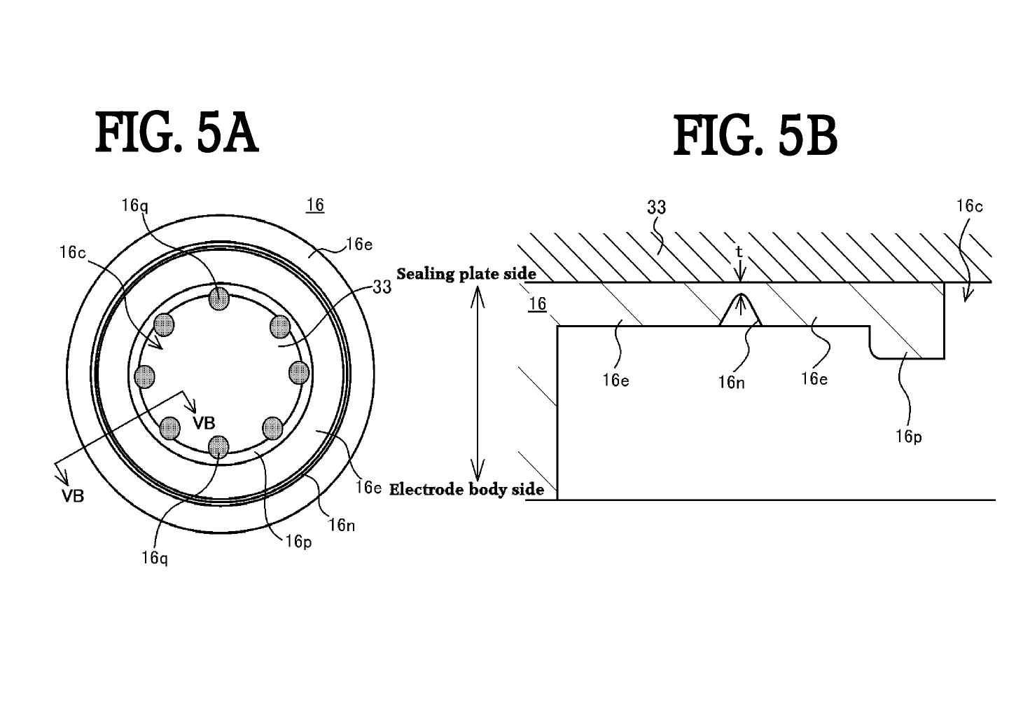

The first region 16a of the positive electrode collector 16 contacts against the center portion of the inversion plate 33. The boundary between the inversion plate 33 and the side surface of the connection forming hole 16c in the thin region 16e formed in the first region 16a is welded at a plurality of locations by irradiation with a laser beam or other high-energy beam. Specifically, as shown in FIGS. 5A and 5B, the thin region 16e formed in the first region 16a of the positive electrode collector 16 has a notch portion (groove) 16n that has a toric shape in planer view and an approximate V-shaped sectional shape, concentrically with the connection forming hole 16c; and a protrusion 16p is formed in a ring-shape at the rim of the connection forming hole 16c. The inner wall portion of the protrusion 16p of the connection forming hole 16c in the positive electrode collector 16 is laser-welded to the inversion plate 33 at a plurality of locations to form connecting portions 16q. Forming the protrusion 16p thickens the rim of the connection forming hole 16c in the positive electrode collector 16. Therefore, it will be easy to weld the boundary between the inversion plate 33 and the side surface of the connection forming hole 16c by irradiation with a laser beam or other high-energy beam, and consequently the quality of the connection portions 16q will be even. An electron beam may be used as the high-energy beam, instead of a laser beam.

It is preferable that the thickness t of the thinnest part of the notch portion 16n formed in a torus shape (see FIG. 5B) be formed so as to be consistent over the whole length L of the torus, so that the density of the current that flows across this portion will be homogeneous, and so that the heating-up when high current flows will be homogeneous. The notch portion 16n is formed so that the product of the thickness t of the thinnest part in the notch portion 16n and the total length L of the notch portion 16n, in other words, the sectional area of the thinnest part of the notch portion 16n is 0.28 to 0.57 mm². The sectional shape of the notch portion 16n may be not only roughly V-shaped but roughly U-shaped or roughly trapezoidal. However, it is most preferably roughly V-shaped, in consideration of ease of formation and of variation in the fracture pressure. In this specification, the expressions “roughly V-shaped”, “roughly U-shaped” and “roughly trapezoidal” are used to include shapes that can be visually judged to be a V-shape, U-shape, or trapezoid that are not necessarily an exact V-shape, U-shape, or trapezoid. For example, the expressions may include shapes that are a distorted V-shape, U-shape, or trapezoid, and may include an V-shape, U-shape, or trapezoid that have parts that should be straight but are curved. Preferably however, the shape is an exact V-shape, U-shape, or trapezoid.

The sectional area of the thinnest part of the notch portion 16n is determined in the following manner. In nonaqueous electrolyte prismatic secondary batteries or nickel-hydrogen storage batteries, aluminum or aluminum alloy, copper or copper alloy, nickel or nickel alloy, or the like are generally used as the material for the positive electrode collector or the negative electrode collector. The lower limit value for the sectional area of the thinnest part of the notch portion 16n is determined at 0.28 mm² so that with collectors formed of any of those materials, the notch portion 16n will not readily heat up and so will not melt in a shorter time than the fuse melts even when high current of 100 to 200 A or so flows through the notch portion 16n. The upper limit value is determined at 0.57 mm² so that, if the pressure inside the outer casing (see FIGS. 1A to 1C) increases, the brittle notch portion 16n reliably fractures and thus the function of the pressure-sensitive current interruption mechanism 35 is achieved. From the results obtained experimentally by the inventors, it was found that it is more preferable that the product of the thickness t of the thinnest part in the notch portion 16n and the total length L of the notch portion 16n be 0.39 to 0.51 mm².

It is preferable that the diameter of the connection forming hole 16c be 1.5 to 4.0 mm. If the diameter of the connection forming hole 16c is less than 1.5 mm, it will be difficult to increase the number of connecting portions 16q formed between the positive electrode collector 16 and the inversion plate 33. This will weaken the bond strength of the connecting portions 16q between the collector 16 and the inversion plate 33, causing a risk that the connecting portions 16q fracture before the brittle notch portion 16n fractures in the event that the pressure inside the battery increases. If the diameter of the connection forming hole 16c exceeds 4.0 mm, the width of the collector 16 will have to be larger correspondingly. The thickness of the prismatic secondary battery 10 will accordingly become larger, which is not preferable.

Furthermore, between the first region 16a of positive electrode collector 16 and the inversion plate 33, there is formed a second insulating member 34 that contains resin material and has a through-hole 34a. The first region 16a of positive electrode collector 16 is electrically connected to the inversion plate 33 through the through-hole 34a. Around this through-hole 34a in the second insulating member 34, there are formed a first projection 34b in the position corresponding to the first opening 16g in the first region 16a of the positive electrode collector 16, a second projection 34c in the position corresponding to the second opening 16h, and a third projection 34d in the position corresponding to the third openings 16j.

The first to third projections 34b to 34d of the second insulating member 34 are inserted into the first to third openings 16g to 16j, respectively, formed in the first region 16a of positive electrode collector 16, and by heating the tips of the first to third projections 34b to 34d to widen their diameters, the second insulating member 34 and the first region 16a of positive electrode collector 16 are fixed to each other. As a result, the first to third projections 34b to 34d of the second insulating member 34 are, thanks to the widened-diameter portions formed in each of them, prevented from falling out from the first to third openings 16g to 16j formed in the first region 16a of positive electrode collector 16, and the second insulating member 34 are robustly joined to the first region 16a of positive electrode collector 16. The first to third fixing portions 30a to 30c are formed from these first to third openings 16g to 16j formed in the first region 16a of positive electrode collector 16 and from the first to third projections 34b to 34d of the second insulating member 34. The second insulating member 34 and the lower first insulating member 20b, which constitute the first insulating member, will preferably be fixed together by engaging to each other. There is no particular restriction on such fixing method, but in this embodiment, the second insulating member 34 and the lower first insulating member 20b constituting the first insulating member are fixed together by means of latch portions 34g.

Thus, the positive electrode substrate exposed portions 14 are electrically connected to the positive electrode external terminal 17 via the second region 16b of the positive electrode collector 16, the first region 16a of the positive electrode collector 16, the thin region 16e, the connecting portions 16q, the inversion plate 33, and the conductive member 32. The current interruption mechanism 35 of this embodiment includes the tubular portion 32a of the conductive member 32, the inversion plate 33, the second insulating member 34, and the thin region 16e, notch portion 16n, and connecting portions 16q that are formed in the first region 16a of the positive electrode collector 16.

Specifically, the inversion plate 33 swells toward the through-hole 17b in the positive electrode external terminal 17 when the pressure inside the outer casing 12 increases. In addition, the first region 16a of the positive electrode collector 16 fractures at the toric notch portion 16n when the pressure inside the outer casing 12 exceeds a particular value, because the thin region 16e, in which the toric notch portion 16n is formed in the first region 16a of the positive electrode collector 16, is welded to the central portion of the inversion plate 33. The electrical connection between the inversion plate 33 and the first region 16a of the positive electrode collector 16 is thus interrupted.

With the toric notch portion 16n thus formed in the thin region 16e, the first region 16a readily fractures at the toric notch portion 16n when the inversion plate 33 is deformed, and reliably fractures at the toric notch portion 16n when the pressure inside the battery increases. This enhances the safety of the prismatic electrolyte nonaqueous secondary battery 10. In addition, the product of the thickness t of the thin region 16e portion of the toric notch portion 16n and the length L of the toric notch portion 16n is kept within the above-mentioned particular range. Thus, in the cases where a plurality of prismatic nonaqueous electrolyte secondary batteries 10 of the embodiment are combined together in a high power system, the toric notch portion 16n of the batteries will be unlikely to heat up and will not melt in a shorter time than the fuse provided for the high power system melts, even if high current of from 100 to 200 A or so flows through the toric notch portion 16n. The pressure at which the toric notch portion 16n fractures can be set as a particular pressure value. Hence the reliability too will be enhanced.

An example has been described here in which a notch portion that is toric, viewed from above, is formed in the peripheral portion of the connection forming hole 16c in the first region 16a. However, this notch portion may alternatively be annular, elliptical, or polygonal. But in consideration of ease of formation, the shape of the notch portion 16n viewed from above is round most preferably. An example has been described here in which a connection forming hole 16c is provided in the first region 16a of the positive electrode collector 16. However, this connection forming hole 16c is not necessarily required. It will suffice to form connecting portions between the inversion plate 33 and the first region 16a of the positive electrode collector 16 by performing piercing welding from either side, generally from the first region 16a side. However, it is best to form the connection forming hole 16c, since otherwise it will be difficult to perform the welding with a high-energy beam, and moreover, unevenness will be prone to occur in the quality of the connecting portions—that is, the welding locations.

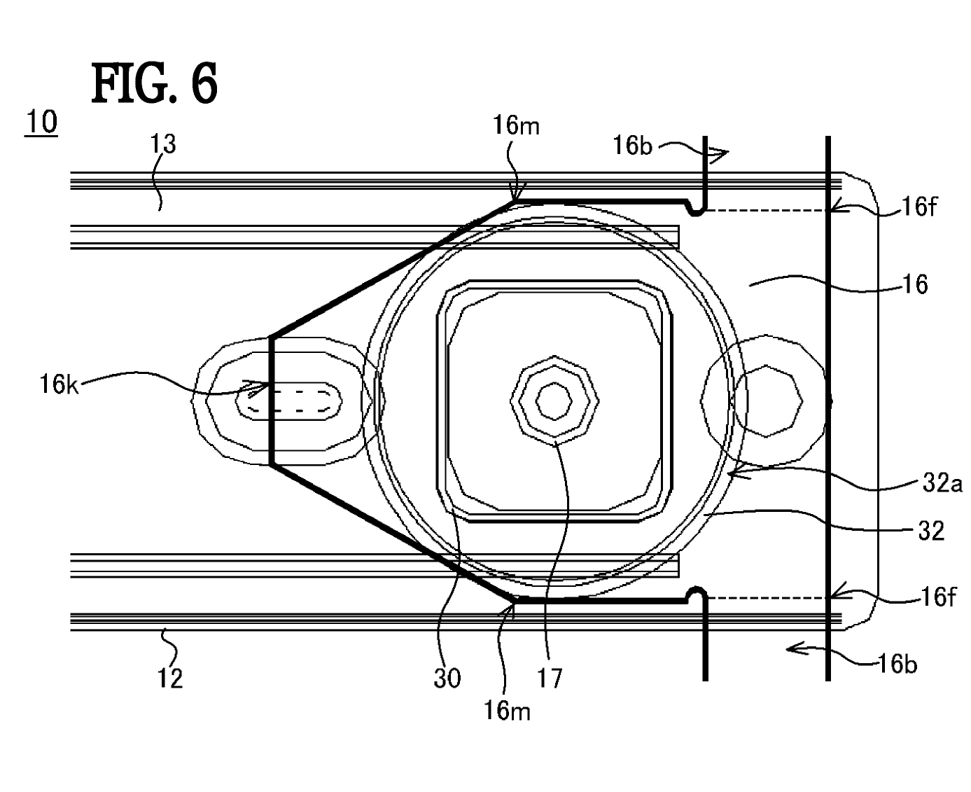

Furthermore, as FIG. 6 shows, in the prismatic nonaqueous electrolyte secondary battery 10 of the embodiment, the boundaries 16f between the first region 16a and the second regions 16b of positive electrode collector 16 are disposed so as to be located further outward than the inner surface of the tubular portion 32a of the conductive member 32. Moreover, one or more edges of the first region 16a, other than the boundaries with the second regions 16b—in this embodiment, all such edges of the first region 16a (protruding edge 16k, side edges 16m and so forth)—are likewise located further outward than the inner surface of the tubular portion 32a of the conductive member 32, so that the first region 16a is so disposed as to be located further outward than the inner surface of the tubular portion 32a of the conductive member 32 in all directions.

With such dispositions, even if the prismatic nonaqueous electrolyte secondary battery 10 is subjected to shock due to vibration, falling, etc., and the wound electrode assembly 11 shifts toward the sealing body 13, the fact that the boundaries 16f between the first region 16a and the second regions 16b of positive electrode collector 16, and the all edges of the first region 16a (protruding edge 16k, side edges 16m and so forth) are disposed so as to be located further outward than the inner surface of the tubular portion 32a of the conductive member 32 means that the first region 16a of positive electrode collector 16, due to contacting against the other edge of the tubular portion 32b of the conductive member 32, will not be able to move any further toward the sealing body 13.

Moreover, the positive electrode collector 16 includes items that have rigidity and cannot be folded by a small force. Thus, when the wound electrode assembly 11 shifts toward the sealing body 13 due to vibration, falling, etc., the force that acts on the first region 16a of positive electrode collector 16 will be absorbed by the second region 16b portions and thus be rendered small. Hence, in the event that the wound electrode assembly 11 shifts toward the sealing body 13 due to vibration, falling, etc., the force exerted to the first region 16a will be small, the possibility of the thin region 16e fracturing will thus be suppressed, and the influence upon the actuation of the pressure-sensitive current interruption mechanism 35 will be small. In this way, a prismatic nonaqueous electrolyte secondary battery 10 with superior reliability will be obtained.

The through-hole 17b in the top part of the positive electrode external terminal 17 is used for testing whether the periphery of the inversion plate 33, which is a component of the current interruption mechanism 35, has been welded hermetically, and may be used in an unchanged state. However, if corrosive gas or liquid enters the through-hole 17b and the inversion plate 33 becomes corroded, a risk will arise that the current interruption mechanism 35 may not operate normally. Thus, it will be preferable to seal up the through-hole 17b of the positive electrode external terminal 17. In the prismatic nonaqueous electrolyte secondary battery 10 of the embodiment, the through-hole 17b formed in the positive electrode external terminal 17 has a large-diameter portion formed toward the exterior of the outer casing 12 and a small-diameter portion formed toward the interior of the outer casing 12. Taking advantage of this configuration, the through-hole 17b of the positive electrode external terminal 17 is robustly sealed by, for example, a rubber terminal plug 36 in its interior.

This terminal plug 36 has: at the upper end, a head portion 36a whose diameter is larger than the small-diameter portion of the through-hole 17b of the positive electrode external terminal 17 and smaller than the large-diameter portion of the through-hole 17b of the positive electrode external terminal 17; at the lower end, a projecting portion 36b whose diameter is smaller than the head portion 36a and larger than the small-diameter portion of the through-hole 17b; latching portions 36c formed in a shape that tapers off from the projecting portion 36b; and in an intermediate position, a connecting portion 36d that has a diameter roughly the same as the small-diameter portion of the through-hole 17b of the positive electrode external terminal 17 and a length substantially the same as such small-diameter portion.

The terminal plug 36 is installed into the through-hole 17b of the positive electrode external terminal 17 in such a manner that the head portion 36a is located at the large-diameter portion of the through-hole 17b, and the latching portions 36c protrude beyond the end of the small-diameter portion of the through-hole 17b. Furthermore, on the surface of the head portion 36a of the terminal plug 36, there is provided a metallic plate 37 of aluminum or other materials, to give the head portion 36a high strength even though its thickness is small. This metallic plate 37 can be weld-fixed to the positive electrode external terminal 17 by laser welding or other methods. The metallic plate 37 could potentially fall out due to vibration, etc., since it is formed of an elastic member. However, weld-fixing the metallic plate 37 to the positive electrode external terminal 17 will render the through-hole 17b more robustly sealed by the terminal plug 36.

Furthermore, in the prismatic nonaqueous electrolyte secondary battery 10 of the embodiment, the space in the current interruption mechanism 35 that corresponds to the exterior is completely sealed. But even if the pressure inside the outer casing 12 increases due to some cause, the pressure of the gases produced inside the battery will become extremely high during abnormality, and there will be no simultaneous similar increase in the pressure inside the sealed space in the current interruption mechanism 35 adjacent to the exterior of the battery. Thus, the space adjacent to the battery exterior being sealed will pose no problem for actuation of the current interruption mechanism 35.

The foregoing description of the prismatic nonaqueous electrolyte secondary battery 10 of the embodiment sets forth an example where the first region 16a of the positive electrode collector 16 has a large width, and two second regions 16b are formed in mutually opposed directions relative to the first region 16a. However, some prismatic nonaqueous electrolyte secondary batteries are small in width and have only one second region formed in the positive electrode collector. The invention can be applied equally to such narrow-width prismatic nonaqueous electrolyte secondary batteries. In such a case, if the second region 16b of a positive electrode collector 16 is placed in contact with one surface of a bunch of stacked positive electrode substrate exposed portions 14 to perform resistance welding, it will suffice to place a positive electrode collector receiving member (omitted from the drawings) formed of the same material as the positive electrode collector 16 in contact with the other surface of the positive electrode substrate exposed portions 14, and to perform the resistance welding by passing the welding current between the second region 16b of the positive electrode collector 16 and the positive electrode collector receiving member.

Furthermore, the foregoing description of the prismatic nonaqueous electrolyte secondary battery 10 of the embodiment sets forth an example where resistance welding is used as the method for connecting the positive electrode collector 16 to the positive electrode substrate exposed portions 14. However, the method is not limited to resistance welding, and may alternatively be laser welding or ultrasonic welding. It would be possible to connect the positive electrode collector 16 to the end surfaces of the tips of the positive electrode substrate exposed portions 14. Furthermore, the foregoing description of the prismatic nonaqueous electrolyte secondary battery 10 of the embodiment sets forth an example where an object of rubber that is provided with a metallic plate 37 is used as the terminal plug 36 that seals the through-hole 17b of the positive electrode external terminal 17. However, an object of plastic may be used, or alternatively the through-hole 17b may be sealed by the metallic plate 37 alone.

Although the foregoing description of the prismatic nonaqueous electrolyte secondary battery 10 of the embodiment concerned the structure on the positive electrode external terminal 17 side, this can also be employed as the structure for the negative electrode external terminal 19 side. However, if a structure is employed in which the current interruption mechanism 35 is provided on the positive electrode external terminal 17 side, there will be no need to employ a current interruption mechanism on the negative electrode external terminal 19 side, and hence it is possible to employ a simpler structure for the negative electrode external terminal 19 side.

What is claimed is:

1. A prismatic secondary battery comprising:
a prismatic outer casing that has a mouth;
an electrode assembly that is housed inside the prismatic outer casing and has a positive electrode plate and a negative electrode plate;
a positive electrode collector that is electrically connected to the positive electrode plate;
a negative electrode collector that is electrically connected to the negative electrode plate;
a sealing body that seals the mouth of the outer casing and has a first through-hole;
at least one external terminal that is inserted into the first through-hole of the sealing body while being electrically insulated from the sealing body with first insulating member interposed therebetween;
a conductive member that has a tubular portion;
an inversion plate containing conductive material, that is deformed when the battery interior pressure exceeds a particular value; and
a second insulating member that is interposed between the inversion plate and at least one of the positive electrode collector and the negative electrode collector, and in which a second through-hole is formed,
at least one of the positive electrode collector and the negative electrode collector being electrically connected to the inversion plate by a connecting portion through the second through-hole formed in the second insulating member,
one end of the tubular portion of the conductive member being electrically connected to the external terminal, and the other end being sealed by the inversion plate,
at least one of the positive electrode collector and the negative electrode collector having an annular notch portion that encircles the connecting portion, and
the product of the thickness t of the thinnest part of the notch portion and the length L of the annular notch portion being 0.28 to 0.57 mm².

2. The prismatic secondary battery according to claim 1, wherein a third through-hole is formed in at least one of the positive electrode collector and the negative electrode collector, and the boundary between the sides of the third through-hole and the inversion plate is welded at a plurality of locations by irradiation with a high-energy beam.

3. The prismatic secondary battery according to claim 2, wherein the diameter of the third through-hole formed in at least one of the positive electrode collector and the negative electrode collector is 1.5 to 4.0 mm.

4. The prismatic secondary battery according to claim 2, wherein a protrusion is provided around the circumference of the third through-hole formed in at least one of the positive electrode collector and the negative electrode collector.

5. The prismatic secondary battery according to claim 1, wherein the sectional shape of the notch portion is roughly V-shaped, roughly U-shaped, or roughly trapezoidal.

6. The prismatic secondary battery according to claim 1, wherein the shape of the annular notch portion viewed from above is round, elliptical, or polygonal.

7. The prismatic secondary battery according to claim 1, wherein a positive electrode external terminal and a negative electrode external terminal is provided as the external terminals.

8. The prismatic secondary battery according to claim 1, wherein the electrode assembly is formed in a flattened shape and has a plurality of stacked positive electrode exposed portions at one end and a plurality of stacked negative electrode exposed portions at the other end, with the positive electrode exposed portions being disposed so as to face to one sidewall of the prismatic outer casing and the negative electrode exposed portions being disposed so as to face to the other sidewall of the prismatic outer casing, and with the positive electrode collector being connected to the positive electrode exposed portions and the negative electrode collector being connected to the negative electrode exposed portions.
